(19) United States
(12) Patent Application Publication
(10) Pub. No.: US 2018/0157391 A1
(43) Pub. Date: Jun. 7, 2018

(54) Page Information Personalization Method, Apparatus and System

(71) Applicant: Alibaba Group Holding Limited, Grand Cayman (KY)

(72) Inventors: Yuefei Wang, Hangzhou (CN); Xi Chen, Hangzhou (CN); Yanming Guo, Hangzhou (CN)

(21) Appl. No.: 15/829,729

(22) Filed: Dec. 1, 2017

(30) Foreign Application Priority Data
Dec. 2, 2016 (CN) 201611109699.0

(51) Int. Cl. G06F 3/0484

(52) U.S. Cl. CPC G06F 3/0484

(57) ABSTRACT

A method, an apparatus and a system of page information personalization are disclosed. The method includes receiving personalized configuration information of a target page after operations of target page construction and data placement are completed, the personalized configuration information including a target information dimension related to the target page when a personalized processing is performed; and adding the personalized configuration information into the target page when the target page is published, to enable a first client page rendering component to obtain page published information of the target page after receiving a request for accessing the target page, determine a user identifier of a visiting user, extract the personalized configuration information from the page published information, determine personalized preference information of the user based on the user identifier, and arrange resources in the target page and rendering the target page based on the personalized preference information and the personalized configuration information.

### CROSS REFERENCE TO RELATED PATENT APPLICATIONS

This application claims foreign priority to Chinese Patent Application No. 201611109699.0, filed on Dec. 2, 2016, entitled “Page Information Personalization Method, Apparatus and System,” which is hereby incorporated by reference in its entirety.

### TECHNICAL FIELD

The present disclosure relates to the technological field of page information processing, and particularly to page information personalization methods, apparatuses and systems.

### BACKGROUND

In some large-scale network sales platforms, business parties usually launch some large-scale sales promotion events. Each launched event needs to develop a corresponding event venue page, e.g., an event venue page for a “Singles' Day” event, etc. In order to facilitate the generation of this type of event pages, some sales platforms provide systems used for constructing pages to operational staffs. This type of page construction systems can provide different modules to users (page developers). The users can select modules from a module pool to assemble a page framework. A process of assembling 100 is like building blocks, and a page can be built up from N modules, as shown in FIG. 1. As shown in the left side of FIG. 1, each small block represents a module. After modules are selected, data content are placed into these specific modules to generate complete page content. A page that is developed using the above method needs to be displayed to a user at the end after the page is published. For example, as shown in the right side of FIG. 1, a page thereof presents five modules, which include a banner module, level (a level may include product pit locations in a row of four or other arrangement methods) modules, etc.

An operational staff can conveniently construct a page using this type of method. However, aspects such as arranging modules require lots of time, to make page content receive likes from many users, and thus obtain a relatively high page click rate, conversion rate, etc. However, different users have different preferences with respect to aspects such as shopping preferences in a real application. Therefore, even though a survey has been performed in advance, some or even a large number of users may select to close a page directly because of failing to find information of interest thereto in a first screen or earlier positions of the page, thus limiting an improvement in aspects such as a click rate, a conversion rate, etc.

Therefore, how to further improve a stay time of a user in a page and thereby improve a page conversion rate becomes a technical problem that needs to be solved by one skilled in the art.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure provides a method, an apparatus and a system for personalizing page information, which can improve an efficiency of generating a page and a conversion rate of the page.

The present disclosure provides the following solutions.

In implementations, a page information personalization system includes a first page construction server used for receiving personalized configuration information of a target page after operations of constructing the target page and placing data are completed, adding the personalized configuration information into the target page when the target information is published, the personalized configuration information including a target information dimension related to the target page when a personalized processing is performed; a first client page rendering component used for obtaining page published information of the target page when a request for accessing the target page is received, determining a user identifier of a visiting user, extracting the personalized configuration information from the published information of the target page, and sending a request for obtaining a personalized computation result to a first algorithmic server with the user identifier and the personalized configuration information as parameters; and the first algorithmic server used for obtaining personalized preference information of the user based on information of the user identifier, arranging resources in the target page based on the personalized preference information and the personalized configuration information of the page, to enable the client page rendering component to perform rendering of the target page based on a result of the arranging.

In implementations, a page information personalization method includes receiving personalized configuration information of a target page after a first page construction server complete operations of constructing the target page and placing data, the personalized configuration information including a target information dimension related to the target page when a personalized processing is performed; and adding the personalized configuration information into the target page when the target page is published, to enable a first client page rendering component to obtain page published information of the target page after receiving a request for accessing the target page, determine a user identifier of a visiting user, extract the personalized configuration information from the page published information, determine personalized preference information of the user based on the user identifier, and arrange resources in the target page and perform rendering for the target page based on the personalized preference information and the personalized configuration information of the target page.

In implementations, a page information personalization method includes a client obtaining page published information of a target page in response to receiving a request for accessing the target page, determining a user identifier of a visiting user, and extracting personalized configuration information from the page published information, the personalized configuration information including a target information dimension related to the target page when a personalized processing is performed; sending a request for obtaining a personalized computation result with the user identifier and the personalized configuration information as parameters to a first algorithmic server, to enable the first algorithmic server to return a resource arrangement result; and rendering the target page based on the resource arrangement result.

In implementations, a page information personalization method includes a first algorithmic server receiving an invocation request of a first client page rendering component, the request being sent by the first client page rendering component in response to receiving a request for accessing a target page, the invocation request including a user identifier of a visiting user and personalized configuration information of the target page, and the personalized configuration information including a target information dimension related to the target page when a personalized processing is performed; obtaining personalized preference information of the user based on information of the user identifier; and making an arrangement for resources in the target page based on the personalized preference information and the personalized configuration information of the target page, and returning an arrangement result to enable the first client page rendering component to perform rendering of the target page based on the arrangement result of the resources.

In implementations, a page information personalization apparatus, which is applied in a first page construction server, includes a personalized configuration information receiving unit used for receiving personalized configuration information of a target page after operations of constructing the target page and placing data are completed, the personalized configuration information including a target information dimension related to the target page when a personalized processing is performed; and a page information publishing unit used for adding the personalized configuration information into the target page when the target page is published, to enable a first client page rendering component to obtain page published information of the target page after receiving a request for accessing the target page, determine a user identifier of a visiting user, extract the personalized configuration information from the page published information, determine personalized preference information of the user based on the user identifier, and arrange resources in the target page and perform rendering for the target page based on the personalized preference information and the personalized configuration information of the target page.

In implementations, a page information personalization apparatus, which is applied in a client terminal, includes a personalized configuration extraction unit used for obtaining page published information of a target page after receiving a request for accessing the target page, determining a user identifier of a visiting user, and extracting personalized configuration information from the page published information, the personalized configuration information including a target information dimension related to the target page when a personalized processing is performed; a request unit used for sending a request for obtaining a personalized computation result with the user identifier and the personalized configuration information as parameters to a first algorithmic server, to enable the first algorithmic server to return a resource arrangement result; and a rendering unit used for rendering the target page based on the resource arrangement result.

In implementations, a page information personalization apparatus, which is applied in a first algorithmic server, includes an invocation request receiving unit used for receiving an invocation request of a first client page rendering component, the request being sent by the first client page rendering component in response to receiving a request for accessing a target page, the invocation request including a user identifier of a visiting user and personalized configuration information of the target page, and the personalized configuration information including a target information dimension related to the target page when a personalized processing is performed; a personalized preference information determination unit used for obtaining personalized preference information of the user based on information of the user identifier; and an arrangement unit used for making an arrangement for resources in the target page based on the personalized preference information and the personalized configuration information of the target page, and returning an arrangement result to enable the first client page rendering component to perform rendering of the target page based on the arrangement result of the resources.

In implementations, a page information personalization system includes a second page construction server used for receiving personalized configuration information of a target page after operations of constructing the target page and placing data are completed, and adding the personalized configuration information when the target page is published, wherein the personalized configuration information includes a target information dimension related to the target page when a personalized processing is performed, and property values of related modules in the target page under the target information dimension; a second client page rendering component used for obtaining page published information of the target page after receiving a request for accessing the target page, determining a user identifier of a visiting user, extracting the personalized configuration information from the published information of the target page, and sending to a second algorithmic server a request for obtaining a personalized computation result with the user identifier, the personalized configuration information and data placement results related to the modules as parameters; and the second algorithmic server used for obtaining personalized preference information of the user based on information of the user identifier, performing the personalized processing on an arrangement of the modules in the target page and respective data object information in the modules based on the personalized preference information, the personalized configuration information of the page and a data placement result related to the modules, to enable the first client page rendering component to perform rendering of the target page based on a result of the personalized processing.

According to the exemplary embodiments provided in the present disclosure, the present disclosure discloses the following technical effects.

Using the embodiments of the present disclosure, after operations of page construction and data placement are completed, the page may undergo personalized configuration. When the page is published, personalized configuration information is added into page data. As such, when the page is initialized according to an access request of a user, resources of the page can be arranged in accordance with personalized preference information of the user and the personalized configuration information. An example includes arranging modules and/or arranging specific data object information in the modules, etc. In this way, when a page is constructed, information such as a particular order of arrangement of resources does not need to be specified. Rather, only which modules need to be added into a page, and what data needs to be related to each module are needed to be specified. These pieces of information can be unordered when the page is constructed and even after the page is published. An arrangement is performed only when an access request of a user is received, and the arrangement is performed according to personalized preference information of the user. As such, an operational staff is allowed to only focus on module selection and data placement when constructing the page, without paying attention to the arrangement issue. Therefore, an efficiency of page generation can be improved. Furthermore, a page that is finally provided to a user satisfies browsing habits of the user in a better manner because some or all of the resources therein are arranged according to personalized preference information of the user. This therefore helps to encourage the user to stay in the page for a longer time, and helps to improve a conversion rate of the page.

Apparently, any product implementing the present disclosure does not need to achieve all of the above advantages at the same time.

### BRIEF DESCRIPTION OF THE DRAWINGS

In order to describe technical solutions of the embodiments of the present disclosure in a better manner, accompanying drawings that are needed by the embodiments are briefly described herein. Apparently, the accompanying drawings described herein merely represent some embodiments of the present disclosure. One skilled in the art can also obtain other drawings based on these accompanying drawings without making any creative effort.

FIG. 1 shows a schematic diagram of page modules.

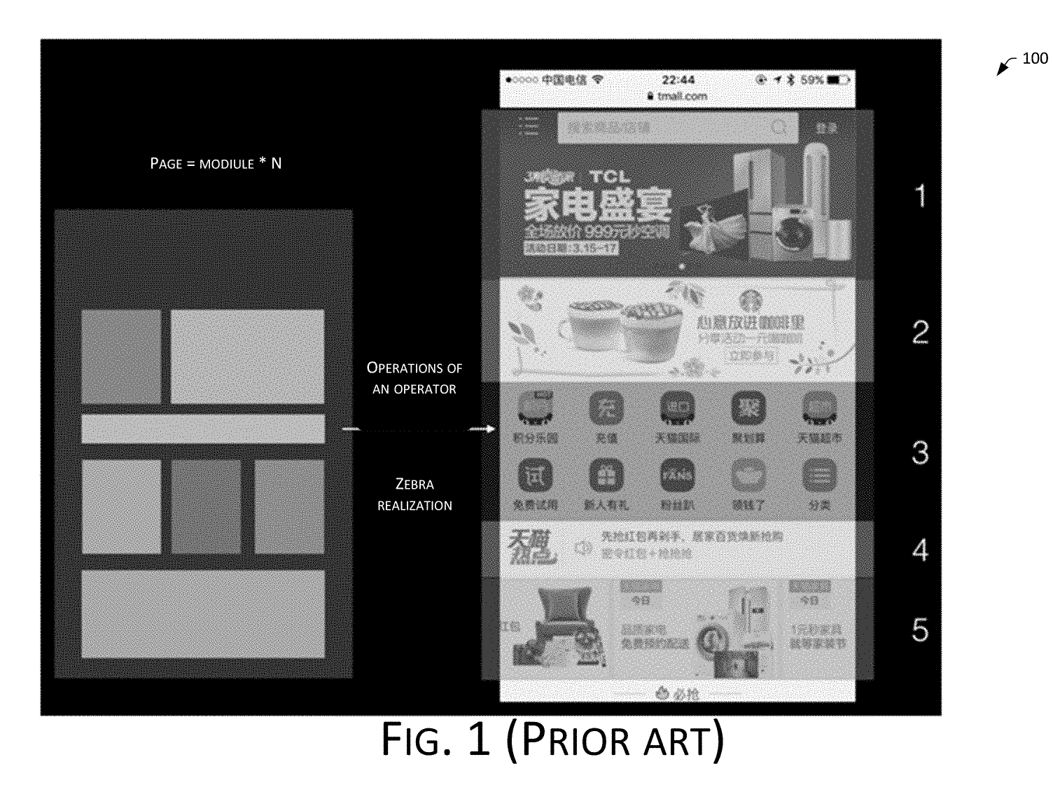

FIG. 2 shows a schematic diagram of a first system provided in the embodiments of the present disclosure.

FIG. 3 shows a schematic structural diagram of a system provided in the embodiments of the present disclosure.

FIG. 4 shows a flowchart of a first method provided in the embodiments of the present disclosure.

FIG. 5 shows a flowchart of a second method provided in the embodiments of the present disclosure.

FIG. 6 shows a flowchart of a third method provided in the embodiments of the present disclosure.

FIG. 7 shows a schematic diagram of a first apparatus provided in the embodiments of the present disclosure.

FIG. 8 shows a schematic diagram of a second apparatus provided in the embodiments of the present disclosure.

FIG. 9 shows a schematic diagram of a third apparatus provided in the embodiments of the present disclosure.

FIG. 10 shows a schematic diagram of a second system provided in the embodiments of the present disclosure.

### DETAILED DESCRIPTION

The technical solutions of the embodiments of the present disclosure are described clearly and comprehensively in conjunction with the accompanying drawings of the embodiments of the present disclosure. Apparently, the described embodiments merely represent some and not all of the embodiments of the present disclosure. All the other embodiments that can be obtained by one of ordinary skill in the art based on the embodiments in the present disclosure should fall in the scope of protection of the present disclosure.

In implementations, in order to improve a stay time of a user in a page and thus improve a conversion rate of the page, resources of the page may be arranged or ordered (which may include arranging/ordering modules and/or arranging/ordering respective data object information in the module, etc.) according to personalized preference information of the user when the page is initialized according to an access request of the user, after operations of page construction and data placement are completed and the page is published. In this way, when a page is constructed, information such as a particular order of arrangement of resources does not need to be specified. Instead, only which modules need to be added into a page, and what data needs to be related to each module are needed to be specified. These pieces of information can be unordered when the page is constructed and even after the page is published. An arrangement or ordering is performed only when an access request of a user is received, and the arrangement or ordering is performed according to personalized preference information of the user. For example, a certain user likes data objects of a category of mums and babies, and modules corresponding to this category can be placed in a foremost position, etc. As such, an operational staff is allowed to only focus on module selection and data placement when constructing a page, without paying attention to a specific arrangement issue. Therefore, an efficiency of page generation can be improved. Furthermore, a page that is finally provided to a user satisfies browsing habits of the user in a better manner because some or all of the resources therein are arranged according to personalized preference information of the user. This therefore helps to encourage the user to stay in the page for a longer time, and helps to improve a conversion rate of the page.

In order to achieve the aforementioned purpose, the embodiments of the present disclosure provide corresponding technical support. First, after module selection and data placement are completed and before a page is published in a process of constructing the page, an option of operation that is used for inputting personalized configuration information may also be provided to a page construction user. Personalized information of the page can be configured through this option of operation. Information that is configured here usually is information having conditional in nature, such as which page needs to undergo personalized processing under which target information dimension, including a category dimension, a data set dimension, etc. Apparently, other configuration information may also be included, and related description is introduced at the later section. After this type of configuration information is received, this configuration information can be added into page data when the page is published. The type of page data is not actually presented on the front part of the page, but can control a presentation method of display content on the front page of the page, for example.

After the page is published, a client terminal can access this page. In the embodiments of the present disclosure, the client may also be added with a page rendering component. The page rendering component may be used for processing an arrangement of resources in the page according to personalized preference information of a user when the page is initialized.

When a personalized processing is performed, an algorithmic platform may also be used. The algorithmic platform may provide an invocation interface to the page rendering component. When resources in a certain page need to be arranged, the page rendering component can call the interface of the algorithmic platform, and send related parameters thereto. The parameters may include a user identifier of the visiting user, and personalized configuration information of the instant page. In this way, the algorithmic platform may perform an arrangement for the resources of the page based on the parameters, and return an arrangement result. The page rendering component can then render the page according to the arrangement result. In this way, display information of the page that is generated after the rendering can manifest the personalized preference information of the user.

Exemplary embodiments are described in detail herein.

### First Embodiment

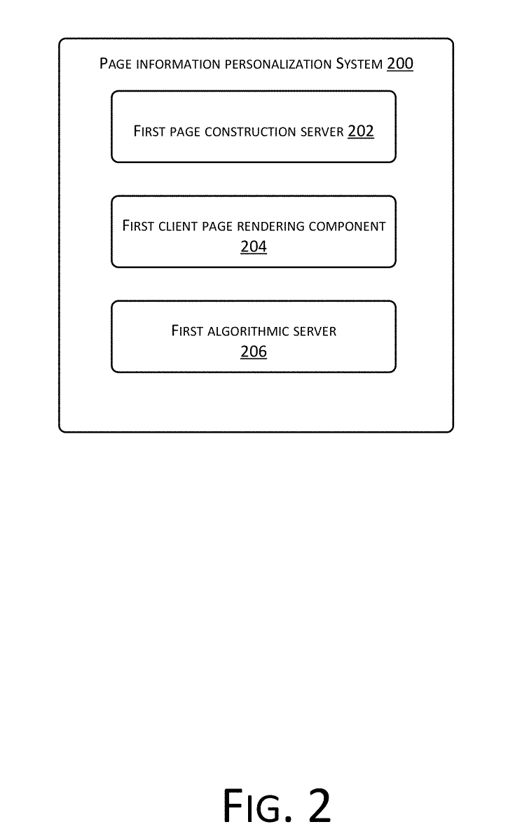

The first embodiment provides a page information personalization system 200. Referring to FIG. 2, the exemplary system 200 may include a first page construction server 202 used for receiving personalized configuration information of a target page after operations of constructing the target page and placing data are completed, adding the personalized configuration information into the target page when the target information is published, the personalized configuration information including one or more target information dimensions related to the target page when a personalized processing is performed; a first client page rendering component 204 used for obtaining page published information of the target page when a request for accessing the target page is received, determining a user identifier of a visiting user, extracting the personalized configuration information from the published information of the target page, and sending a request for obtaining a personalized computation result to a first algorithmic server with the user identifier and the personalized configuration information as parameters; and the first algorithmic server 206 used for obtaining personalized preference information of the user based on information of the user identifier, arranging resources in the target page based on the personalized preference information and the personalized configuration information of the page, to enable the client page rendering component to perform rendering of the target page based on a result of the arranging.

The first page construction server 202 may provide an optional module pool. An operational staff can select modules that are needed from the module pool to construct a page according to specific business requirements. The first page construction server may also access a data placement system, and may place data into the modules using the data placement system after the modules are added. For a banner module, a result of data placement may generally be a generation of information such as an address of a banner image. For most of other modules, corresponding data placement results are usually a data set. An example may be a set formed by data objects that satisfy certain selection rule(s) and are selected by the data placement system from a big data object base according to the selection rule(s). Generally, data objects in a same data set have shared or common characteristic label(s), such as ankle boot, biker jacket, etc.

After a selection of modules and a placement of data are completed, the page may be published. In implementation, the page may be published using a conventional method in existing technologies. In the embodiments of the present disclosure, the operational staff may also configure personalized information of the page prior to publishing thereof. In implementations, the first page construction server 202 may provide an option of operation used for submitting configuration information. The operational staff can perform personalized configuration through this option. In implementations, the configuration information can include at least one or more target information dimensions related to a target page when undergoing personalized processing, i.e., specifying under which dimension the target page to undergo the personalized processing. For example, a specific information dimension may be a category dimension, or may also be a dimension of feature label(s) of a data set, etc. If the category dimension is used, resources of the page can be arranged according to personalized preference information of a user with respect to categories when the resources in the page are arranged at a later stage. For example, a user likes a category of children fashion, and resources related to the category of children fashion may have priority to be placed in the most important position(s), etc. If personalized processing is performed under a dimension of feature label(s) of a data set, the resources of the page may be arranged according to personalized preference information of the user with respect to the features label(s). For example, a feature label of the user include “baby's mum”, and resources related to products for babies and mums, children fashion, etc., may have priority to be placed in the most important position(s), etc.

After personalized configuration is completed, the first page construction server 202 can publish the page, and add the personalized configuration information of the page into page data. After the page is published, a user can access the page via a client terminal. Correspondingly, when the client terminal receives an access request, the first client page rendering component 204 may obtain related page published information which includes the personalized configuration information of the page. The first client page rendering component 204 may then render the page according to the personalized configuration information of the page after receiving the access request for the page. In implementations, when personalized processing is performed, the first algorithmic server 206 may be used. The first algorithmic server 206 may provide an invocation interface to the page rendering component. When resources of a certain page need to be arranged, the page rendering component can call the interface of the first algorithmic server 206, and transmit related parameters thereto. The parameters may include a user identifier of a visiting user, and personalized configuration information of the instant page, etc. As such, the first algorithmic server 206 can set up an arrangement of the resources of the page according to the parameters, and return an arrangement result. The page rendering component may then initialize the page according to the arrangement result.

When the first algorithmic server 206 sets up the arrangement of the resources of the page, this may specifically means setting up an order of various modules in the page. In this case, the personalized configuration information of the page may further include property values of various modules in the target page under the one or more target information dimensions. For example, if a target information dimension is a category dimension, specific categories corresponding to modules may be set in the configuration information. For example, a module A belongs to a category of women' fashion, a module B belongs to a category of men' fashion, etc. If a target information dimension is a dimension of feature label(s) of a data set, specific feature labels corresponding to the modules may be set in the configuration information. For example, a module A corresponds to ankle boot, a module B corresponds to biker fashion, etc. In implementations, since information is more specific when feature label(s) of a data set is/are used for personalized processing as compared to a category, an arrangement result that has a higher degree of matching with personalized preference of the user can be obtained more easily.

Under a situation of setting property values related to the modules, the first algorithmic server 206 may perform an arrangement of the modules in the target page based on the personalized preference information and the personalized configuration information of the page, to enable the first client page rendering component to perform rendering of the target page based on a result of the arrangement of the modules.

As described in the foregoing text, the one or more target information dimensions include(s) a dimension of data object category. Property values of the modules under the one or more target information dimensions include specific categories to which data objects that are placed in the modules commonly belong. The first algorithmic server 206 may be used for obtaining personalized preference information of the user with respect to one or more categories of one or more data objects based on information of the user identifier, and performing an arrangement of the modules based on the personalized preference information and target categories corresponding to the modules. For example, categories that are of interest to the user may be women' fashion, babies and mums, beauty makeup, etc. Modules corresponding to these types of categories may be placed in more important positions. For example, the user may be allowed to view modules corresponding to categories that are of interest thereto in the first screen or first few screens.

Additionally or alternatively, the one or more target information dimensions include(s) a dimension of feature label(s) of a data set. Property values of the modules under this target information dimension includes specific feature labels that are commonly possessed by data objects related to the modules. In this case, the first algorithmic server 206 may be used for obtaining feature label(s) related to the user based on the information of the user identifier, and performing an arrangement of the modules based on the feature label(s) related to the user and the specific feature labels corresponding to the modules. Similar to the category dimension, if feature label(s) of the user is/are found to include “80's generation”, “yummy mummy”, “ankle boot”, “biker fashion”, etc., a matching can be performed according to the specific feature labels corresponding to the modules and the feature label(s) of the user, and the modules are arranged according to respective degrees of matching, for example. The personalized preference information of the user may be maintained by a designated server, and can be queried and obtained from the server based on information such as an identifier of a user, which is not described in further detail herein.

Apparently, in a real application, other than performing personalized processing for the modules, each data object in each module may similarly go through personalized selection and arrangement. In implementations, the first client page rendering component 204 may further be used for providing information of a data placement result related to the modules in the target page to the first algorithmic server 206, when sending the request to the first algorithmic server. In this case, the first algorithmic server 206 may further be used for performing selection and arrangement of data object information from the data placement result based on the data placement result related to the modules and the personalized preference information of the user, and returning a result of selection and arrangement of the data object information in the modules to the first client page rendering component, to enable the first client page rendering component to arrange respective data objects in the modules according to the arrangement result of the modules and the result of selection and arrangement of the data object information in the modules.

The data placement result related to the modules may generally be data set identification information. After sending this information to the first algorithmic server 206, the first algorithmic server 206 may determine specific data objects stored in specific data sets, and select a number of data object that satisfy user preference from the data sets based on the personalized preference information of the user. An arrangement may further be performed, and rendering may be performed using this result of selection and arrangement.

It should be noted that the following situation may exist in modules related to a target page in a real application: certain display area(s) may be formed by multiple modules. For example, a display area corresponding to a certain “level” may include a banner module and a “pit” module. The banner module is mainly used for displaying a specific “level” banner, and the pit module displays multiple resource positions, with each resource position being used for displaying information of a specific data object in the level. In this type of situation, these two modules are treated as a same modular group for processing during the process of personalized arrangement. In other words, regardless of how an arrangement is to be performed, modules of a same modular group need to be together throughout the time, and are not distributed into different locations of a page (which leads to an error in the style of the page). Accordingly, in the embodiments of the present disclosure, if the page includes at least one modular group, modules in the same modular group need to be grouped together for display. Therefore, for member modules belonging to the modular group, the personalized configuration information may further include a group identifier of the member modules. In this case, when an arrangement is performed, the first algorithmic server 206 may group modules having a same group identifier into a modular group, treat the modular group as a module, and add thereof into an algorithm for a calculation of the arrangement. It should be noted that generally only one member module is used for displaying actual data object information in a situation where a same modular group includes multiple modules. Therefore, only this module possesses particular property values in a target information dimension in configuration information, and other member modules are generally used as banners only, for example, without possessing property values. Therefore, personalized configuration information of one member module in a same modular group may be used as personalized configuration information of that modular group.

The foregoing description provides example implementations of an arrangement of modules, or personalized arrangements among and inside the modules at the same time. In a particular implementation, personalized processing of a page may be implemented merely from the perspective of selection and arrangement of data objects within modules. In this case, when sending a request to the first algorithmic server, the first client page rendering component may provide a data placement result related to the modules in the target page to the first algorithmic server 206. The first algorithmic server 206 may be used for performing selection and arrangement of data object information from the data placement result related to the modules based on the one or more target information dimensions, the data placement result related to the modules and the personalized preference information of the user, and returning thereof to the first client page rendering component, to enable the first client page rendering component to render the target page according to a result of selection and arrangement in the modules.

It should be noted that a same page may include a plurality of different modules in a real application, and different modules possess different natures. Some modules may actually have a need for personalized processing, and other modules may not have this need. For example, with respect to a banner module, a function thereof is to display a banner image, which is used for rendering an atmosphere of a page, for example. This module is usually displayed at the top of the page, and therefore usually does not have a need for personalized processing. Accordingly, when personalized configuration is performed, modules which need to undergo personalized configuration and modules which does not need to undergo the personalized configuration are separately marked. In other words, the personalized configuration information may further include whether a module needs to be opened for personalized configuration, to enable the first algorithmic server 206 to perform arrangements for modules that are opened for personalized configuration only.

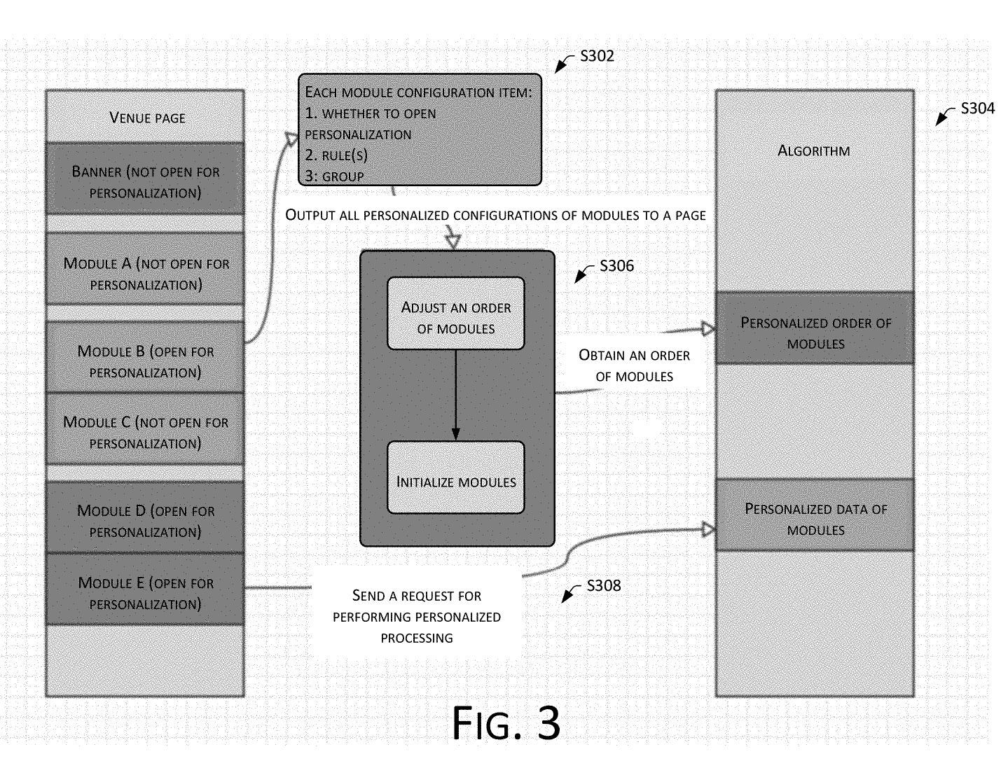

For example, a venue page includes a banner module, a module A, a module B, a module C, etc., as shown in FIG. 3. The banner module and the module A are not opened for personalized configuration, and other modules are opened for personalized configuration. Whether to open personalized configuration may be set in a configuration item at S302. Each module may correspond to a configuration item, which may include whether to open for personalization, rule information (i.e., a specific belonging category, or specific feature label(s) possessed thereby, etc.), group information (if belonging to a certain modular group, a corresponding group identifier can be set). When the page is published, this type of configuration information is inputted into the page. In implementations, when rendering is performed for the page, arrangement information of the modules and/or personalized information in the modules, etc., can be obtained from the first algorithmic server based on the personalized preference information of the user and personalized configuration information of the modules at S304. An arrangement of the modules is adjusted accordingly, and the modules are initialized at S306. A request for performing personalized processing on data in the modules is sent to obtain data in the modules, and rendering is then performed using these pieces of data, to facilitate a provision thereof to the client terminal for page presentation at S308.

Using the embodiments of the present disclosure, after operations of page construction and data placement are completed, the page may also undergo personalized configuration. Furthermore, when the page is published, personalized configuration information is added into page data. As such, when the page is initialized according to an access request of a user, resources of the page can be arranged in accordance with personalized preference information of the user and the personalized configuration information. A specific example includes arranging modules and/or arranging specific data object information in the modules, etc. In this way, when a page is constructed, information such as a particular order of arrangement of resources does not need to be specified. Rather, only which modules need to be added into a page, and what data needs to be related to each module are needed to be specified. These pieces of information can be unordered when the page is constructed and even after the page is published. An arrangement is performed only when an access request of a user is received, and the arrangement is performed according to personalized preference information of the user. As such, an operational staff is allowed to only focus on module selection and data placement when constructing the page, without paying attention to the arrangement issue. Therefore, an efficiency of page generation can be improved. Furthermore, a page that is finally provided to a user satisfies browsing habits of the user in a better manner because some or all of the resources therein are arranged according to personalized preference information of the user. This therefore helps to encourage the user to stay in the page for a longer time, and helps to improve a conversion rate of the page.

### Second Embodiment

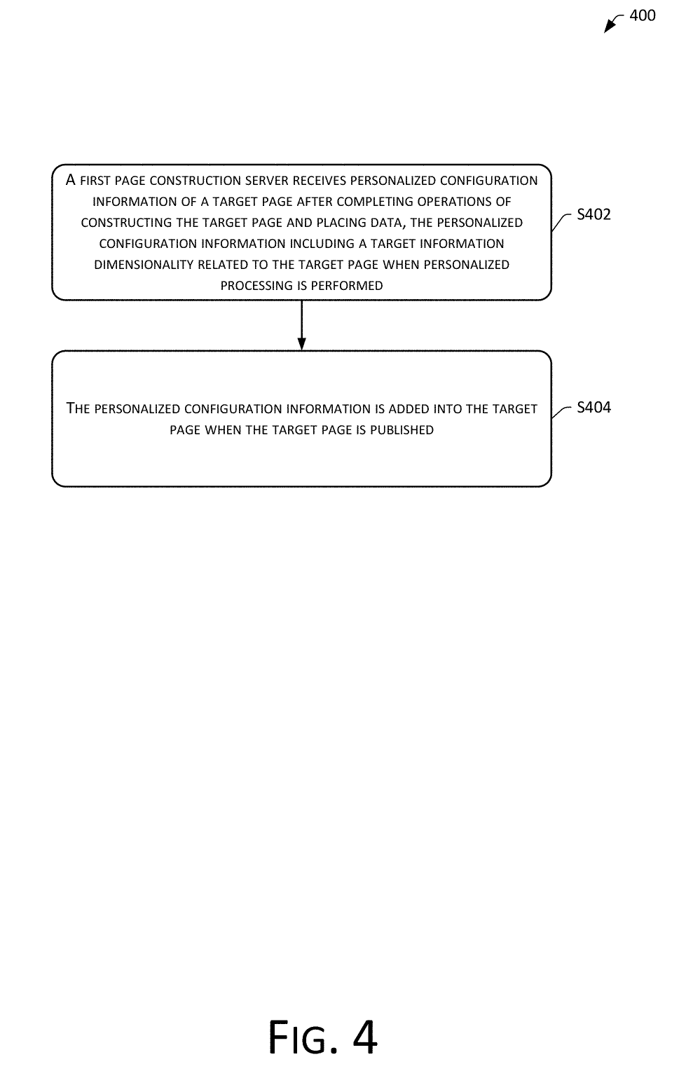

This second embodiment corresponds to the first embodiment, and provides a page information personalization method from the perspective of a first page construction server. Referring to FIG. 4, the example method 400 may include the following operations.

S402: A first page construction server receives personalized configuration information of a target page after completing operations of constructing the target page and placing data, the personalized configuration information including a target information dimension related to the target page when personalized processing is performed.

S404: The personalized configuration information is added into the target page when the target page is published, to enable a first client page rendering component to obtain page published information of the target page after receiving a request for accessing the target page, determine a user identifier of a visiting user, extract the personalized configuration information from the page published information, determine personalized preference information of the user based on the user identifier, and arrange resources in the target page and perform rendering for the target page based on the personalized preference information and the personalized configuration information of the target page.

The personalized configuration information also includes property values of modules related to the target page under the target information dimension, to facilitate arranging the modules in the target page.

### Third Embodiment

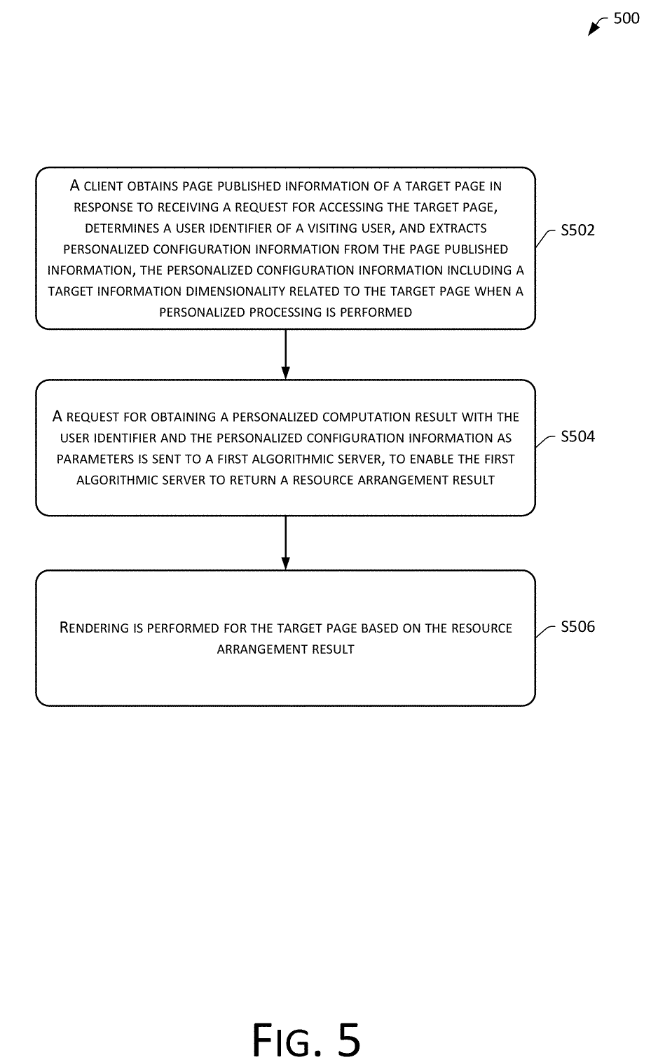

This third embodiment corresponds to the first embodiment, and provides a page information personalization method from the perspective of a first client page rendering component. Referring to FIG. 5, the example method 500 may include the following operations.

S502: A client obtains page published information of a target page in response to receiving a request for accessing the target page, determines a user identifier of a visiting user, and extracts personalized configuration information from the page published information, the personalized configuration information including a target information dimension related to the target page when a personalized processing is performed.

S504: A request for obtaining a personalized computation result with the user identifier and the personalized configuration information as parameters is sent to a first algorithmic server, to enable the first algorithmic server to return a resource arrangement result.

S506: Rendering is performed for the target page based on the resource arrangement result.

### Fourth Embodiment

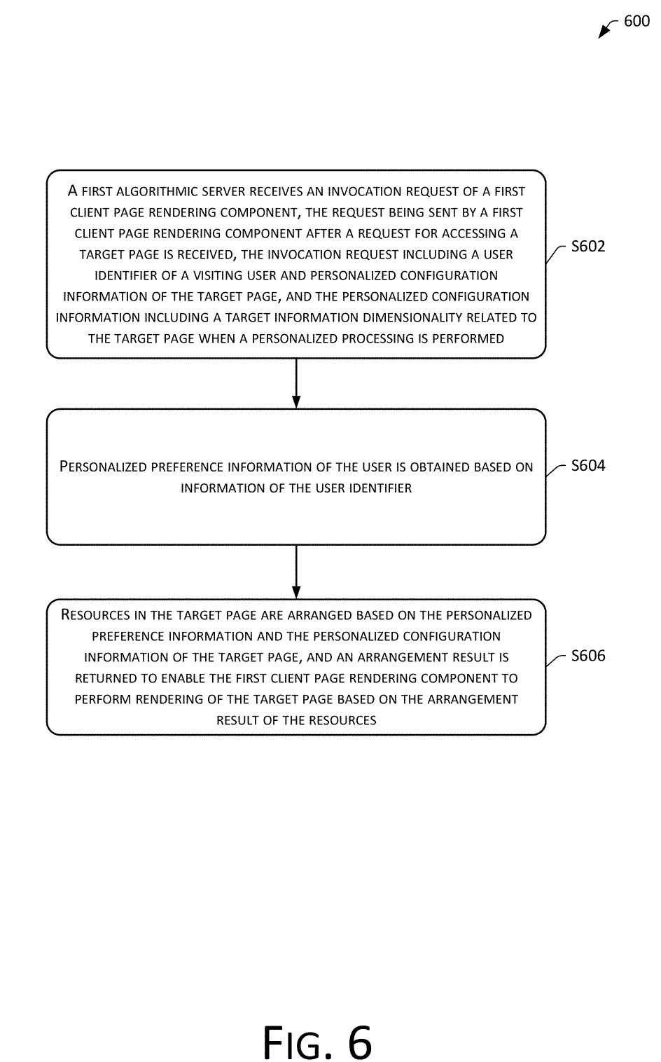

This fourth embodiment corresponds to the first embodiment, and provides a page information personalization method from the perspective of a first algorithmic server. Referring to FIG. 6, the example method 600 may include the following operations.

S602: A first algorithmic server receives an invocation request of a first client page rendering component, the request being sent by a first client page rendering component after a request for accessing a target page is received, the invocation request including a user identifier of a visiting user and personalized configuration information of the target page, and the personalized configuration information including a target information dimension related to the target page when a personalized processing is performed.

S604: Personalized preference information of the user is obtained based on information of the user identifier.

S606: Resources in the target page are arranged based on the personalized preference information and the personalized configuration information of the target page, and an arrangement result is returned to enable the first client page rendering component to perform rendering of the target page based on the arrangement result of the resources.

The personalized configuration information may also include property values of modules related to the target page under the target information dimension. In this case, the modules in the target page can be arranged based on the personalized preference information and the personalized configuration information of the page.

Alternatively, the invocation request may also include information of a data placement result related to the modules in the target page. In this case, selection and arrangement of data object information is performed from the data placement result based on the data placement result related to the modules and the personalized preference information of the user.

Details of implementations of the foregoing second to fourth embodiments can be referenced to the description of the first embodiment, and are not redundantly described herein.

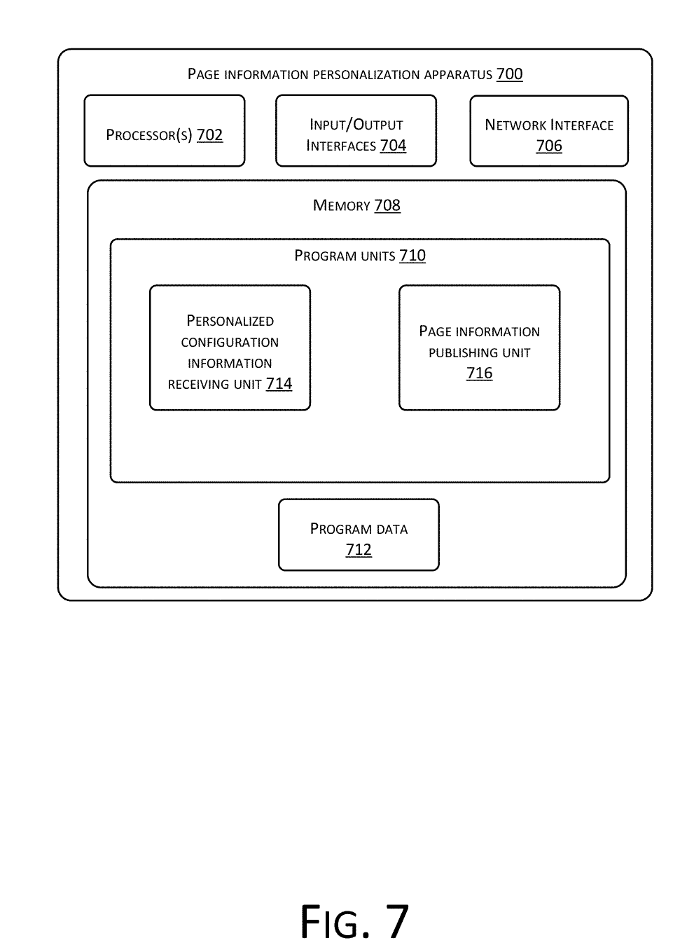

Corresponding to the second embodiment, the present disclosure further provides a page information personalization apparatus. In implementations, the page information personalization apparatus may include one or more computing devices, or may be a part of one or more computing devices. In implementations, the page information personalization apparatus 700 may be applied in a first page construction server. Referring to FIG. 7, the apparatus 700 may include one or more processors 702, an input/output (I/O) interface 704, a network interface 706, and memory 708.

The memory 708 may include a form of computer readable media such as a volatile memory, a random access memory (RAM) and/or a non-volatile memory, for example, a read-only memory (ROM) or a flash RAM. The memory 708 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 708 may include program units 710 and program data 712. The program units 710 may include a personalized configuration information receiving unit 714 used for receiving personalized configuration information of a target page after operations of constructing the target page and placing data are completed, the personalized configuration information including a target information dimension related to the target page when a personalized processing is performed; and a page information publishing unit 716 used for adding the personalized configuration information into the target page when the target page is published, to enable a first client page rendering component to obtain page published information of the target page after receiving a request for accessing the target page, determine a user identifier of a visiting user, extract the personalized configuration information from the page published information, determine personalized preference information of the user based on the user identifier, and arrange resources in the target page and perform rendering for the target page based on the personalized preference information and the personalized configuration information of the target page.

The personalized configuration information further includes property values of modules related to the target page under the target information dimension, to facilitate arranging the modules in the target page.

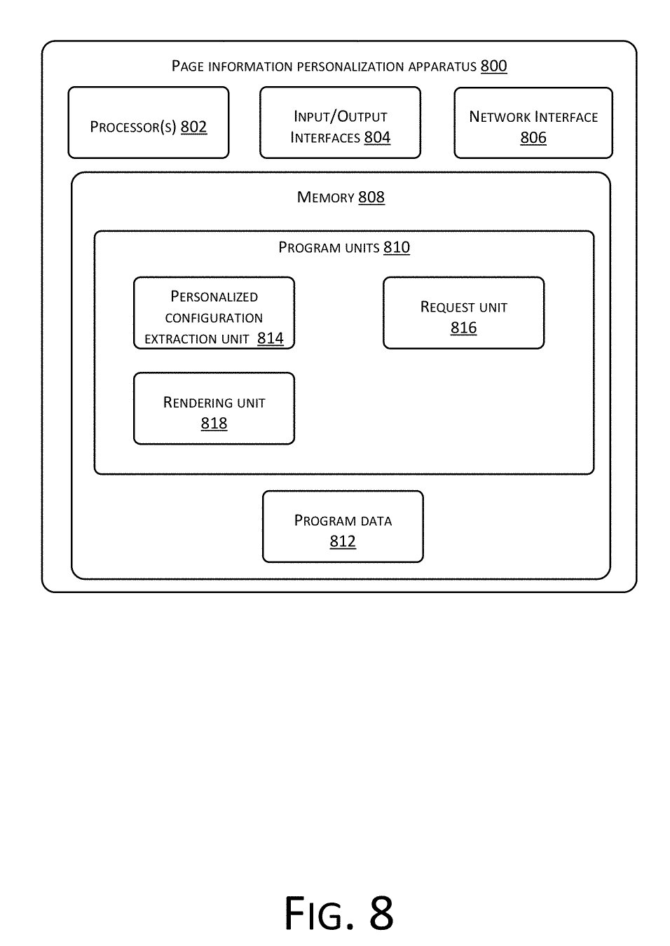

Corresponding to the third embodiment, the present disclosure further provides a page information personalization apparatus. In implementations, the page information personalization apparatus may include one or more computing devices, or may be a part of one or more computing devices. In implementations, the information personalization apparatus 800 may be applied in a client terminal. Referring to FIG. 8, the apparatus 800 may include one or more processors 802, an input/output (I/O) interface 804, a network interface 806, and memory 808. The memory 808 is an example of a computer readable media as described in the foregoing description.

In implementations, the memory 808 may include program units 810 and program data 812. The program units 810 may include a personalized configuration extraction unit 814 used for obtaining page published information of a target page after receiving a request for accessing the target page, determining a user identifier of a visiting user, and extracting personalized configuration information from the page published information, the personalized configuration information including a target information dimension related to the target page when a personalized processing is performed; a request unit 816 used for sending a request for obtaining a personalized computation result with the user identifier and the personalized configuration information as parameters to a first algorithmic server, to enable the first algorithmic server to return a resource arrangement result; and a rendering unit 818 used for rendering the target page based on the resource arrangement result.

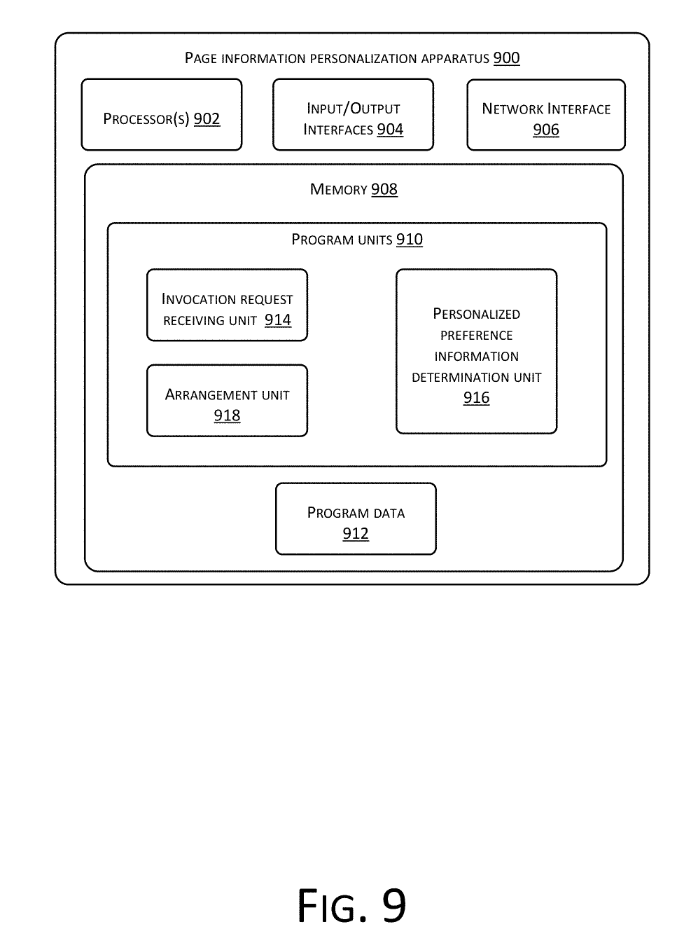

Corresponding to the fourth embodiment, the present disclosure further provides a page information personalization apparatus. In implementations, the page information personalization apparatus may include one or more computing devices, or may be a part of one or more computing devices. In implementations, the page information personalization apparatus 900 may be applied in a first algorithmic server. Referring to FIG. 9, the apparatus 900 may include one or more processors 902, an input/output (I/O) interface 904, a network interface 906, and memory 908. The memory 908 is an example of a computer readable media as described in the foregoing description.

In implementations, the memory 908 may include program units 910 and program data 912. The program units 910 may include an invocation request receiving unit 914 used for receiving an invocation request of a first client page rendering component, the request being sent by the first client page rendering component in response to receiving a request for accessing a target page, the invocation request including a user identifier of a visiting user and personalized configuration information of the target page, and the personalized configuration information including a target information dimension related to the target page when a personalized processing is performed; a personalized preference information determination unit 916 used for obtaining personalized preference information of the user based on information of the user identifier; and an arrangement unit 918 used for making an arrangement for resources in the target page based on the personalized preference information and the personalized configuration information of the target page, and returning an arrangement result to enable the first client page rendering component to perform rendering of the target page based on the arrangement result of the resources.

The personalized configuration information may also include property values of modules related to the target page under the target information dimension. The arrangement unit 918 may be used for arranging the modules in the target page based on the personalized preference information and the personalized configuration information of the page.

Additionally or alternatively, the invocation request may also include information of a data placement result related to the modules in the target page. The arrangement unit 918 may be used for selecting and arranging data object information from the data placement result based on the data placement result related to the modules and the personalized preference information of the user.

### Fifth Embodiment

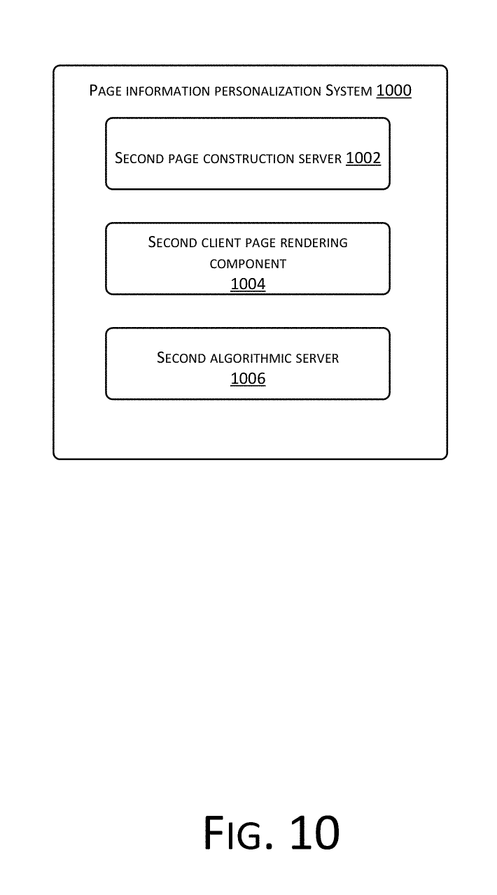

In the fifth embodiment, a page information personalization system is provided. In the system, all the resources in a page can undergo personalized processing, which may include personalized processing for an arrangement of modules, and personalized processing for data objects in the modules. Personalized processing in the modules may include selecting and arranging the data objects in the modules, selecting representative images for specific data objects, etc. Selecting the representative images for the data objects may be performed based on historical activity records of a user, for example. In implementations, referring to FIG. 10, the system 1000 may include a second page construction server 1002 used for receiving personalized configuration information of a target page after operations of constructing the target page and placing data are completed, and adding the personalized configuration information when the target page is published, wherein the personalized configuration information includes a target information dimension related to the target page when a personalized processing is performed, and property values of related modules in the target page under the target information dimension; a second client page rendering component 1004 used for obtaining page published information of the target page after receiving a request for accessing the target page, determining a user identifier of a visiting user, extracting the personalized configuration information from the published information of the target page, and sending to a second algorithmic server a request for obtaining a personalized computation result with the user identifier, the personalized configuration information and data placement results related to the modules as parameters; and the second algorithmic server 1006 used for obtaining personalized preference information of the user based on information of the user identifier, performing the personalized processing on an arrangement of the modules in the target page and respective data object information in the modules based on the personalized preference information, the personalized configuration information of the page and a data placement result related to the modules, to enable the first client page rendering component to perform rendering of the target page based on a result of the personalized processing.

Using the fifth embodiment, personalized processing for all the resources of a page can be implemented. Personalized processing can be performed for ordering an arrangement of modules, selection and arrangement of data objects in the modules, and selection of a representative image corresponding to each data object, etc., based on personalized preference of a user, thus achieving comprehensive personalization.

It should be noted that specific implementations in the fifth embodiments can also be referenced to the description of the foregoing embodiments, and are not repeatedly described herein.

As can be seen from the description of the above embodiments, one skill in the art can clearly understand that the present disclosure can be implemented in a form of a software component with a necessary hardware platform. Based on this understanding, the essence of the technical solutions of the present disclosure or the portions that provide contributions to the existing technologies can be implemented in a form of a software product. This computer software product may be stored in storage media, such as ROM/RAM, a magnetic disk, an optical disk, etc., and includes instructions used for causing a computing device (which can be a personal computer, a mobile device, a server, or a networked device, etc.) to perform the method described in the embodiments or portions of the embodiments of the present disclosure.

The embodiments of the present disclosure are described in a progressive manner. The same or similar portions of the embodiments can be referenced with each other. Each embodiment places an emphasis differently from other embodiments. Because of being basically similar to the method embodiments, the systems or system embodiments are described relatively briefly, and can be referenced to related portions of the method embodiments. The foregoing systems and system embodiments are merely exemplary. Units that are described as separate components may or may not be physically separate. A component that is presented as a unit may or may not be a physical unit, i.e., may be located in a single location, or may be distributed among a plurality of network units. Some or all of the modules may be selected to implement the purpose of the solution of the present embodiments based on actual needs. One of ordinary skill in the art can understand and implement the present disclosure without making any creative effort.

A method, an apparatus and a system of page information personalization provided by the present disclosure are described in detail above. The present specification uses specific examples to describe the principles and embodiments of the present disclosure. The description of the above embodiments is merely used to help understand the methods and concepts of the present disclosure. Based on the concepts of the present disclosure, one of ordinary skill in the art can make changes to the specific embodiments and application scopes. In short, content of the present specification should not be construed as limitations to the present disclosure.

The present disclosure may further be understood with clauses as follows.

Clause 1: A page information personalization system comprising: a first page construction server used for receiving personalized configuration information of a target page after operations of constructing the target page and placing data are completed, adding the personalized configuration information into the target page when the target information is published, the personalized configuration information including a target information dimension related to the target page when a personalized processing is performed; a first client page rendering component used for obtaining page published information of the target page when a request for accessing the target page is received, determining a user identifier of a visiting user, extracting the personalized configuration information from the published information of the target page, and sending a request for obtaining a personalized computation result to a first algorithmic server with the user identifier and the personalized configuration information as parameters; and the first algorithmic server used for obtaining personalized preference information of the user based on information of the user identifier, arranging resources in the target page based on the personalized preference information and the personalized configuration information of the page, to enable the client page rendering component to perform rendering of the target page based on a result of the arranging.

Clause 2: The system of Clause 1, wherein the personalized configuration information further comprises property values of modules related to the target page under the target information dimension, and the first algorithmic server is used for arranging the modules in the target page based on the personalized preference information and the personalized configuration information of the page, to enable the client page rendering component to perform rendering of the target page based on an arrangement result of the modules.

Clause 3: The system of Clause 2, wherein the target information dimension comprises a data object category dimension, and the property values of the modules under the target information dimension includes common categories to which data objects placed in the modules belong, and wherein the first algorithmic server is used for obtaining personalized preference information of the user with respect to data object categories, and arranging the modules based on the personalized preference information of the user with respect to the categories of the data objects and respective target categories corresponding to the modules.

Clause 4: The system of Clause 2, wherein the target information dimension comprises a dimension of feature label(s) of a data set, and the property values of the module under the target information dimension comprises feature labels commonly possessed by data objects that are related to the modules, and wherein the first algorithmic server us used for obtaining feature label(related to the user based on the information of the user identifier, and performing an arrangement of the modules based on the feature label(s) related to the user and the feature labels corresponding to the modules.

Clause 5: The system of Clause 2, wherein the first client page rendering component is further used for providing a data placement result related to the modules in the target page to the first algorithmic server when sending a request to the first algorithmic server, and the first algorithmic server is further used for performing a selection and a arrangement of data object information from the data placement result based on the data placement result related to the modules and the personalized preference information of the user, and returning a result of selection and arrangement in the modules to the first client page rendering component, to enable the first client page rendering component to arrange data objects in the modules based on the arrangement result of the modules and the result of selection and arrangement in the modules.

Clause 6: The system of Clause 2, wherein the modules related to the target page comprises at least one modular group, a plurality of modules in the modular group being grouped together for presentation, and the personalized configuration information further includes a group identifier of each member module belonging to the modular group and wherein the first algorithmic server is used for grouping modules having a same group identifier as a particular modular group, and treating the particular modular group as a single module to be added into an algorithm for performing calculation of the arrangement.

Clause 7: The system of Clause 1, wherein: the first client page rendering component is further used for providing a data placement result related to modules in the target page to the first algorithmic server when sending a request to the first algorithmic server, and the first algorithmic server is further used for performing selection and arrangement of data object information from the data placement result related to the modules based on the target information dimension, the data placement result related to the modules and the personalized preference information of the user, and returning a result of selection and arrangement in the modules to the first client page rendering component, to enable the first client page rendering component to render the target page according to the result of selection and arrangement in the modules.

Clause 8: The system of any one of Clauses 1-7, wherein the personalized configuration information further comprises whether to open personalized configuration for each module, and the first algorithmic server performs arrangement for one or more modules for which the personalized configuration is opened.

Clause 9: A page information personalization method comprising: receiving personalized configuration information of a target page after a first page construction server complete operations of constructing the target page and placing data, the personalized configuration information including a target information dimension related to the target page when a personalized processing is performed; and adding the personalized configuration information into the target page when the target page is published, to enable a first client page rendering component to obtain page published information of the target page after receiving a request for accessing the target page, determine a user identifier of a visiting user, extract the personalized configuration information from the page published information, determine personalized preference information of the user based on the user identifier, and arrange resources in the target page and perform rendering for the target page based on the personalized preference information and the personalized configuration information of the target page.

Clause 10: The method of Clause 9, wherein the personalized configuration information further comprises property values of modules related to the target page under the target information dimension, to help performing an arrangement of the modules in the target page.

Clause 11: A page information personalization method comprising: a client obtaining page published information of a target page in response to receiving a request for accessing the target page, determining a user identifier of a visiting user, and extracting personalized configuration information from the page published information, the personalized configuration information including a target information dimension related to the target page when a personalized processing is performed; sending a request for obtaining a personalized computation result with the user identifier and the personalized configuration information as parameters to a first algorithmic server, to enable the first algorithmic server to return a resource arrangement result; and rendering the target page based on the resource arrangement result.

Clause 12: A page information personalization method includes a first algorithmic server receiving an invocation request of a first client page rendering component, the request being sent by the first client page rendering component in response to receiving a request for accessing a target page, the invocation request including a user identifier of a visiting user and personalized configuration information of the target page, and the personalized configuration information including a target information dimension related to the target page when a personalized processing is performed; obtaining personalized preference information of the user based on information of the user identifier; and making an arrangement for resources in the target page based on the personalized preference information and the personalized configuration information of the target page, and returning an arrangement result to enable the first client page rendering component to perform rendering of the target page based on the arrangement result of the resources.

Clause 13: The method of Clause 12, wherein the personalized configuration information further comprises property values of modules related to the target page under the target information dimension, and making the arrangement for the resources in the target page comprises arranging the modules in the target page based on the personalized preference information and the personalized configuration information of the page.

Clause 14: The method of Clause 12, wherein the invocation request further comprises information of a data placement result related to modules in the target page, and making the arrangement for the resources in the target page comprises selecting and arranging data object information in the data placement result based on the data placement result related to the modules and the personalized preference information of the user.

Clause 15: A page information personalization apparatus, which is applied in a first page construction server, includes a personalized configuration information receiving unit used for receiving personalized configuration information of a target page after operations of constructing the target page and placing data are completed, the personalized configuration information including a target information dimension related to the target page when a personalized processing is performed; and a page information publishing unit used for adding the personalized configuration information into the target page when the target page is published, to enable a first client page rendering component to obtain page published information of the target page after receiving a request for accessing the target page, determine a user identifier of a visiting user, extract the personalized configuration information from the page published information, determine personalized preference information of the user based on the user identifier, and arrange resources in the target page and perform rendering for the target page based on the personalized preference information and the personalized configuration information of the target page.

Clause 16: A page information personalization apparatus, which is applied in a client terminal, includes a personalized configuration extraction unit used for obtaining page published information of a target page after receiving a request for accessing the target page, determining a user identifier of a visiting user, and extracting personalized configuration information from the page published information, the personalized configuration information including a target information dimension related to the target page when a personalized processing is performed; a request unit used for sending a request for obtaining a personalized computation result with the user identifier and the personalized configuration information as parameters to a first algorithmic server, to enable the first algorithmic server to return a resource arrangement result; and a rendering unit used for rendering the target page based on the resource arrangement result.

Clause 17: A page information personalization apparatus, which is applied in a first algorithmic server, includes an invocation request receiving unit used for receiving an invocation request of a first client page rendering component, the request being sent by the first client page rendering component in response to receiving a request for accessing a target page, the invocation request including a user identifier of a visiting user and personalized configuration information of the target page, and the personalized configuration information including a target information dimension related to the target page when a personalized processing is performed; a personalized preference information determination unit used for obtaining personalized preference information of the user based on information of the user identifier; and an arrangement unit used for making an arrangement for resources in the target page based on the personalized preference information and the personalized configuration information of the target page, and returning an arrangement result to enable the first client page rendering component to perform rendering of the target page based on the arrangement result of the resources.

Clause 18: A page information personalization system includes a second page construction server used for receiving personalized configuration information of a target page after operations of constructing the target page and placing data are completed, and adding the personalized configuration information when the target page is published, wherein the personalized configuration information includes a target information dimension related to the target page when a personalized processing is performed, and property values of related modules in the target page under the target information dimension; a second client page rendering component used for obtaining page published information of the target page after receiving a request for accessing the target page, determining a user identifier of a visiting user, extracting the personalized configuration information from the published information of the target page, and sending to a second algorithmic server a request for obtaining a personalized computation result with the user identifier, the personalized configuration information and data placement results related to the modules as parameters; and the second algorithmic server used for obtaining personalized preference information of the user based on information of the user identifier, performing the personalized processing on an arrangement of the modules in the target page and respective data object information in the modules based on the personalized preference information, the personalized configuration information of the page and a data placement result related to the modules, to enable the first client page rendering component to perform rendering of the target page based on a result of the personalized processing.

Clause 19: The system of Clause 18, wherein the second algorithmic server is used for selecting data objects that satisfy a personalized preference of the user from a data set related to the modules when performing the personalized processing on the data object information in the modules, making an arrangement based on respective degrees of matching with the personalized preference, and selecting representative images of the selected data objects based on the personalized preference information of the user, to enable a presentation of the representative images in corresponding resource positions of corresponding modules.

What is claimed is:

1. A method comprising:
receiving personalized configuration information of a target page; and
adding the personalized configuration information into the target page when the target page is published, the personalized configuration information enabling a client terminal to render the target page and arrange resources in the target page based at least in part on the personalized configuration information.

2. The method of claim 1, wherein the personalized configuration information comprises a target information dimension related to the target page when a personalized processing is performed.

3. The method of claim 2, wherein the target information dimension comprises at least one of a category dimension or a dimension of a feature label of a data set.

4. The method of claim 1, wherein the personalized configuration information of the target page is received after operations of a construction of the target page and a placement of data are completed.

5. The method of claim 1, further comprising:
providing a module pool including a plurality of modules from which one or more modules are selected to construct the target page; and
accessing a data placement system to place data into the one or more selected modules based on one or more selection rules.

6. The method of claim 5, wherein the one or more selection rules comprises placing data objects having a common characteristic label into a same module of the one or more modules.

7. One or more computer-readable media storing executable instructions that, when executed by one or more processors, cause the one or more processors to perform acts comprising:
receiving an invocation request of a first client page rendering component, the invocation request including a user identifier of a user and personalized configuration information of a target page;
obtaining personalized preference information of the user based on information of the user identifier;
determining an arrangement of resources in the target page based on the personalized preference information and the personalized configuration information of the target page; and
returning as a result of the arrangement to the first client page rendering component for rendering the target page based on the result of the arrangement.

8. The one or more computer-readable media of claim 7, wherein the personalized configuration information comprises one or more target information dimensions related to the target page when a personalized processing is performed.

9. The one or more computer-readable media of claim 8, wherein the one or more target information dimensions comprise at least one of a category dimension or a dimension of a feature label of a data set.

10. The one or more computer-readable media of claim 8, wherein the one or more target information dimensions comprises a category dimension, and obtaining the personalized preference information comprises obtaining personalized preference information of the user with respect to one or more categories of data objects in a plurality of modules related to the target page based on the information of the user identifier.

11. The one or more computer-readable media of claim 10, wherein determining the arrangement of the resources in the target page comprises determining an arrangement of the plurality of modules related to the target page based on the personalized preference information and the one or more categories of the data objects in the plurality of modules.

12. The one or more computer-readable media of claim 8, wherein the one or more target information dimensions comprises a dimension associated with at least feature label of a data set, and the acts further comprise obtaining one or more feature labels related to the user based on the information of the user identifier, and obtaining a plurality of feature labels commonly possessed by data objects in modules related to the target page.

13. The one or more computer-readable media of claim 12, the acts further comprising determining an arrangement of the plurality of modules based on the one or more feature labels related to the user and the plurality of feature labels of the data objects in the plurality of modules.

14. The one or more computer-readable media of claim 12, the acts further comprising:
matching between the one or more feature labels related to the user and the plurality of feature labels of the data objects in the plurality of module; and
arranging the modules according to respective degrees of matching between the one or more feature labels related to the user and the plurality of feature labels of the data objects in the plurality of module.

15. The one or more computer-readable media of claim 7, the acts further comprising:
receiving information of a data placement result related to a plurality of modules of the target page from the first client page rendering component;
performing a selection and an arrangement of data objects related to the plurality of modules of the target page based on the data placement result and the personalized preference information of the user; and
returning a result of the selection and the arrangement of the data objects related to the plurality of modules to the first client page rendering component to enable the first client page rendering component to arrange the data objects in the plurality of modules according to the result of the arrangement result and the result of the selection and the arrangement of the data object information in the plurality of modules.

16. The computer-readable media of claim 15, wherein the data placement result comprises data set identification information, and performing the selection and the arrangement of the data objects related to the plurality of modules of the target page comprises selecting a number of data objects that satisfy one or more preferences of the user from a plurality of data sets based on the personalized preference information of the user.

17. The computer-readable media of claim 7, wherein the resources comprise a plurality of modules, and determining the arrangement of the resources in the target page comprises grouping at least some modules as a modular group, and treating the modular group as a single module in the arrangement of the resources.

18. An apparatus comprising:
one or more processors;
memory;
a personalized configuration extraction unit stored in the memory and executable by the one or more processors to obtain page published information of a target page after receiving a request for accessing the target page, determine a user identifier of a user, and extract personalized configuration information from the page published information;
a request unit stored in the memory and executable by the one or more processors to send a request for obtaining a personalized computation result to a first algorithmic server, and receive a resource arrangement result from the first algorithmic server, the request including the user identifier and the personalized configuration information as parameters; and
a rendering unit stored in the memory and executable by the one or more processors to render the target page based on the resource arrangement result.

19. The apparatus of claim 18, wherein the personalized configuration information comprises a target information dimension related to the target page when a personalized processing is performed.

20. The apparatus of claim 18, wherein at least some resources possess a same group identifier, and the rendering unit is further configured to group the at least some resources as a group for presentation.
